(19) United States
(12) Patent Application Publication
(10) Pub. No.: US 2014/0280131 A1
(43) Pub. Date: Sep. 18, 2014

(54) Recommendations for Applications Based on Device Context

(71) Applicant: MOTOROLA MOBILITY LLC, Libertyville, IL (US)

(72) Inventors: Johannes Peter Wilhelm Martens, San Francisco, CA (US); Michael D. McLaughlin, San Jose, CA (US)

(21) Appl. No.: 13/903,221

(22) Filed: May 28, 2013

Related U.S. Application Data
(60) Provisional application No. 61/779,837, filed on Mar. 13, 2013.

(51) Int. Cl. G06F 17/30

(52) U.S. Cl. CPC G06F 17/30861
USPC 707/736

(57) ABSTRACT

There is disclosed a mobile device comprising a sensor, a memory and a processor. The sensor collects a first datum associated with a sensed condition of the mobile device. The memory, whether local or remote, is accessible by the mobile device and stores a second datum associated with a usage history of one or more applications resident at the mobile device. The processor selects a particular application, different from the application or applications of the usage history, based on the collected first and second data.

### FIELD OF THE INVENTION

The present invention relates generally to the field of communication devices having multiple applications and, more particularly, a mobile communication device capable of providing a recommendation for one or more of the applications of the device.

### BACKGROUND OF THE INVENTION

With the proliferation of small, but powerful, portable computing devices, there has been an explosion of specialized applications and services that take advantage of the high performance network connectivity, location determination, cameras, and general computing power of such devices to provide timely and useful information to users for a wide range of purposes and situations. Although the abundance of choices of applications and services has provided users with a myriad options and created a highly competitive marketplace, it has also created user confusion and a certain level of stasis with respect to number of applications and services of which users are aware and actually use on a regular basis with any degree of success or efficacy.

In the mobile communication and computing arena, users can download and install small specialized applications, or “apps”, to their individual portable computing devices, e.g., smart phones, tablet computers, laptop computers, heads-up-display (HUD) glasses/goggle, wristwatch, and combinations thereof, to perform specific functions or engage in particular activities. Such functions and activities range from playing games and sharing photographs to banking and finding real estate properties. As used herein, the term application may refer to any type of standalone or Internet connected application, program, or subroutine executed in any layer in the computing environment, e.g., in the operating system, in the middleware layer, or as a top layer application.

Conventional mobile computing operating systems and applications require that the user know the name of each application, the function and capabilities of each application, and know how to quickly launch the application from the user interface of his/her mobile computing device. Not only are such systems awkward and arduous to use to perform various everyday functions, such systems can also hinder, and in some scenarios prevent, a user from discovering new and useful applications or services already installed on, or otherwise available to, his/her mobile computing device. If the user does not know that an application exists for particular function, and does not actively go looking for it using a search engine, then it is unlikely that such a user will learn about or otherwise be exposed to the functionality and capabilities of various new applications and services.

### BRIEF DESCRIPTION OF THE DRAWINGS

FIG. 1 is a perspective view of an embodiment in accordance with the present invention.

FIG. 2 is a block diagram of example components of an embodiment in accordance with the present invention.

FIG. 3 is a block diagram of select parts of the example components of FIG. 2.

FIG. 4 is a conceptual diagram of an example operation in accordance with the present invention.

FIG. 5 is a conceptual diagram of another example operation in accordance with the present invention.

FIG. 6 is a flow diagram of a yet another example operation in accordance with the present invention.

### DETAILED DESCRIPTION OF THE EMBODIMENTS

There is disclosed an enhanced user experience for dynamically determining and recommending relevant software applications, also known as “apps” to the user of a mobile device. A variety of services may provide a user of a mobile device with information. The mobile device may provide recommendations for services or software applications based on certain criteria, such as a location, user profile or current activity of the user of the mobile device. For example, the mobile device may make determinations or recommendations based on the frequency of past usage, usage history of particular software applications, and/or categories of software applications by the user. The usage history of the particular software application may include location, the time of the day, weather conditions, and the like.

One aspect is a method of a mobile device. A sensor of the mobile device collects a first datum associated with a sensed condition of the mobile device. A memory, accessible by the mobile device, collects a second datum associated with a usage history of one or more applications resident at the mobile device. A particular application, different from the application or applications of the usage history, is selected based on the collected first and second data.

Another aspect is a mobile device comprising a sensor, a memory and a processor. The sensor is configured to collect a first datum associated with a sensed condition of the mobile device. The memory, whether local or remote, is accessible by the mobile device and stores a second datum associated with a usage history of one or more applications at the mobile device. The processor is capable of selecting a particular application, different from the application or applications of the usage history, based on the collected first and second data.

Referring to FIG. 1, there is illustrated a perspective view of an example communication device 100. The device 100 may be any type of device capable of storing and executing multiple applications. Examples of the communication device 100 include, but are not limited to, mobile devices, wireless devices, tablet computing devices, personal digital assistants, personal navigation devices, touch screen input device, touch or pen-based input devices, portable video and/or audio players, and the like. It is to be understood that the communication device 100 may take the form of a variety of form factors, such as, but not limited to, bar, tablet, flip/clam, slider, rotator, and wearable form factors.

For one embodiment, the communication device 100 has a housing 101 comprising a front surface 103 which includes a visible display 105 and a user interface. For example, the user interface may be a touch screen including a touch-sensitive surface that overlays the display 105. For another embodiment, the user interface or touch screen of the communication device 100 may include a touch-sensitive surface supported by the housing 101 that does not overlay any type of display. For yet another embodiment, the user interface of the communication device 100 may include one or more input keys 107. Examples of the input key or keys 107 include, but are not limited to, keys of an alpha or numeric keypad or keyboard, a physical keys, touch-sensitive surfaces, mechanical surfaces, multipoint directional keys and side buttons or keys 107. The communication device 100 may also comprise apertures 109, 111 for audio output and input at the surface. It is to be understood that the communication device 100 may include a variety of different combination of displays and interfaces.

The communication device 100 includes one or more sensors 113 positioned at or within an exterior boundary of the housing 101. For example, as illustrated by FIG. 1, the sensor or sensors 113 may be positioned at the front surface 103 and/or another surface (such as one or more side surfaces 115) of the exterior boundary of the housing 101. The sensor or sensors 113 may include an exterior sensor supported at the exterior boundary to detect an environmental condition associated with an environment external to the housing. The sensor or sensors 113 may also, or in the alternative, include an interior sensors supported within the exterior boundary (i.e., internal to the housing) to detect a condition of the device itself Examples of the sensors 113 are described below in reference to FIG. 2.

Referring to FIG. 2, there is shown a block diagram representing example components 200 that may be used for one or more embodiments. The example components may include one or more communication components 201, one or more processors 203, one or more memories 205, one or more output components 207, and one or more input components 209. Each component may include a user interface that comprises one or more input components 209. Each communication component 201 may include a wireless receiver, transmitter or transceiver. Each communication component 201 may utilize wireless technology for communication, such as, but are not limited to, cellular-based communications such as analog communications (using AMPS), digital communications (using CDMA, TDMA, GSM, iDEN, GPRS, or EDGE), and next generation communications (using UMTS, WCDMA, LTE, or IEEE 802.16) and their variants, as represented by cellular transceiver 211. Each communication component 201 may also utilize wireless technology for communication, such as, but are not limited to, peer-to-peer or ad hoc communications such as HomeRF, ANT, Bluetooth and IEEE 802.11(a, b, g or n); and other forms of wireless communication such as infrared technology, as represented by WLAN transceiver 213. Also, each communication component 201 may be a receiver, a transmitter or both.

The example components 200 may further include a device interface 215 to provide a direct connection to auxiliary components or accessories for additional or enhanced functionality. In addition, the example components 200 may include a power source or supply 217, such as a portable battery, for providing power to the other example components and allow portability of the communication device 100.

The processor 203 may generate commands based on information received from one or more communication components 201 and/or one or more input components 209. The processor 203 may process the received information alone or in combination with other data, such as the information stored in the memory 205. Thus, the memory 205 of the example components 200 may be used by the processor 203 to store and retrieve data. The data that may be stored by the memory 205 include, but is not limited to, operating systems, applications, and data. Each operating system includes executable code that controls basic functions of the communication device, such as interaction among the components of the example components 200, communication with external devices via each communication component 201 and/or the device interface (see below), and storage and retrieval of applications and data to and from the memory 205. The memory 205 includes multiple applications, and each application includes executable code utilizes an operating system to provide more specific functionality for the communication device. Data is non-executable code or information that may be referenced and/or manipulated by an operating system or application for performing functions of the communication device.

The input components 209, such as components of the user interface, may produce an input signal in response to detecting a predetermined gesture at a first input component 219, such as a gesture sensor. An example of a gesture sensor is, but not limited to, a touch-sensitive sensor having a touch-sensitive surface substantially parallel to the display. The touch-sensitive sensor may include at least one of a capacitive touch sensor, a resistive touch sensor, an acoustic sensor, an ultrasonic sensor, a proximity sensor, or an optical sensor.

The input components 209 may also include other sensors, such as the visible light sensor, the motion sensor and the proximity sensor described above. Likewise, the output components 207 of the example components 200 may include one or more video, audio and/or mechanical outputs. For example, the output components 207 may include a video output component such as a cathode ray tube, liquid crystal display, plasma display, incandescent light, fluorescent light, front or rear projection display, and light emitting diode indicator. Other examples of output components 207 include an audio output component such as a speaker, alarm and/or buzzer, and/or a mechanical output component such as vibrating or motion-based mechanisms.

It is to be understood that FIG. 2 is provided for illustrative purposes only and for illustrating components of a communication device in accordance with the present invention, and is not intended to be a complete schematic diagram of the various components required for a communication device. Therefore, a communication device may include various other components not shown in FIG. 2, or may include a combination of two or more components or a division of a particular component into two or more separate components, and still be within the scope of the present invention.

Referring to FIG. 3, there is shown a block diagram representing select parts of example components 200 in accordance with one or more embodiments of the present invention. In particular, FIG. 3 represents another perspective of the communication components 201, the one or more processors 203, and the input components 209, described above in reference to FIG. 2. For example, the communication components 201 may include a cellular transceiver 211 (such as a baseband processor) and a WLAN transceiver 213 (such as a Wi-Fi processor). As another example, the one or more processors 203 may include an applications processor separate or distinct from the communication components 201.

Further, the input components 209 may include a sensor hub 301 and various sensors 303-313 that may be included and/or utilized by the device. As shown in FIG. 3, the various sensors 303-313 may be controlled by a sensor hub 223, which may operate in response to or independent of the processor(s) 203. For example, the various sensors 303-313 may be coupled to the sensor hub 301 and, thus, communicate with other components of the example components 201, such as one or more communication components 201 and/or one or more processors 203, via the sensor hub. It is to be understood that, although the various sensors 303-313 are shown separate from the input components of 209, the various sensors are generally considered to be a part of the input components. The various sensors may include, but are not limited to, one or more light sensors 303, one or more capacitive sensors 305, one or more gyroscope-based sensors 307, one or more barometer-based sensors 229, one or more magnetic-based sensors 311, one or more motion sensors 313, and one or more proximity sensors.

Sensor of the example components 200 may be coupled to circuits of the device via the sensor hub 301 or coupled to the circuits independent of the sensor hub. For example, a global positioning system (GPS) circuit 315 may be coupled directly to one or more processors 203 instead of being coupled indirectly to the processor(s) through the sensor hub 301. Even though the circuit(s) may be coupled to circuits independent of the sensor hub 301, the circuit(s) may be coupled to the sensor hub as well.

Referring to FIG. 4, there is shown a conceptual diagram of an example operation 400 in accordance with the present invention. The example operation 400 tracks application usage of users and their devices, together with context including time, location, activity, previous application launches, and the like. The recommendations are based on collaborative filtering, such as applications often used at specific locations, during specific activities, or by a specific user group. The example operation 400 presents the user, at his or her device, an option to try out a new application other users, as indicated by their devices, may have found to be helpful in the similar situations. In addition, the example operation may take care of other operations, such as pre-fetching, installing, and uninstalling the application if not used.

As shown in FIG. 4, the device 401 may submits information 403 associated with the user, or more particularly the user's situation, at step 405. Examples of the user's information 403 may include, but are not limited to location, time identity, and information associated with other devices. The information 403 may then be provided to a ranking engine 407, where applications 411 that correlate with the user's information 403 are identified. Next, the ranking engine 407 ranks the correlated applications 411 in a particular order 415. Thereafter, the ordered applications are provided to the user's device, so that the user is provided the most relevant applications at one or more optimal time periods 419, or on a periodic basis.

Referring to FIG. 5, there is shown a conceptual diagram of another example operation 500 in accordance with the present invention. For this example operation 500, a user may arrive at a vicinity or proximate location of a retail store 501, such as arriving and parking a vehicle 503 in a parking lot 505 of the retail store. While the user 507 walks 509 toward the retail store 501, the mobile device 511 of the user may send 513 via a wireless link the current context 515 associated with the user as noted by the device to a ranker 517. For example, the example operation 500 may lookup relevant applications for the particular location, activity, and/or time of day based on the device's location and/or user's detected behavior (such as exiting the vehicle). The ranker 517 is associated with the retail store 501, and may be co-located with the retail store. The ranker 517 returns 519 via the wireless link an application associated with the retail store 501, which is installed automatically within a certain period of time at the mobile device 511. For example, the example operation 500 may determine a high relevance for an application provided by, or otherwise associated with, the retail store 501. The application associated with the retail store 511 appears as a shortcut 521 at a home screen of the mobile device 511, and the application may be selected or otherwise activated 523 at the mobile device by the user 507.

For one embodiment, the user 507 may have difficulty identifying or finding a location (such as, the appropriate aisle) of a particular product at the retail store. As the user 507 approaches the retail store 501, his or her device may already present the user with a recommendation for a particular application, such as an in-store map and/or aisle locator. The user 507 may then click on the recommendation and the application is launched. The next time the user 507 is at the vicinity or proximity of the retail store 501, the example operation 500 may recommend use of the particular application again so that the user does not need to remember when to use the highly-relevant application or applications.

Referring to FIG. 6, there is shown a flow diagram of a yet another example operation in accordance with the present invention. A sensor of the mobile device 100 may collect a first datum associated with a sensed condition of the mobile device at step 601. An input component 209, such as one of the sensors 303-313 communicating with the sensor hub 301 or one of the other sensors 315, may collect information associated with a sensed condition, such as illumination, human interaction or gestures, orientation, elevation, magnetic conditions, motion, and/or location. For one embodiment, a location sensor of the mobile device 100, such as a GPS circuit 313, may collect location information associated with the mobile device 100.

Next, the device 100 may access, from a storage medium or memory accessible to the mobile device, second datum associated with a usage history of one or more applications resident at the mobile device, at step 603. For one embodiment, the usage history of one or more applications may be monitored to generate the second datum, as indicated by step 605, and the second datum may be stored at a memory 205 of the mobile device, as indicated by step 607. For another embodiment, the usage history of one or more applications may be monitored to generate the second datum, at step 605, and the second datum may be stored at a memory of a remote device, such as an infrastructure server, capable of data communication with the mobile device, at step 607. Although steps 605 and 607 are shown in FIG. 6 to be part of accessing the second datum at step 603, it is to be understood that the steps of monitoring and storing usage history may be executed (at a particular time period or on a periodic basis) before the step 601 of collecting the first datum and/or the step 603 of accessing the second datum.

The second datum associated with the usage history of one or more applications may take a variety of forms. For one embodiment, the usage history of one or more applications resident at the mobile device may include information about one or more previous accesses of the application(s) at the mobile device. For another embodiment, the usage history of one or more applications resident at the mobile device may include a usage history of the application(s) associated with a location of the mobile device. For yet another embodiment, the usage history of one or more applications associated with the location of the mobile device may include usage of the application(s) by the mobile device at the location of the mobile device. For still another embodiment, the usage history of one or more applications associated with the location of the mobile device may include usage of the application(s) by a device other than the mobile device at the location of the mobile device.

Thereafter, the device 100, or a processor 203 of the device, may select an application different from the one or more applications of the usage history based on the collected first and second data, at step 609. For one embodiment, the processor 203 may select an application resident at a memory 205 of the mobile device 100. For another embodiment, the processor 203 may select an application resident at a remote device, such as an infrastructure server, capable of data communication with the mobile device, and the application resident at the remote device may be downloaded to the mobile device via a data communication link there between.

Subsequent to selecting the application at step 609, an output component 207 of the device 100 may provide a notification associated with the downloaded application to the mobile device, at step 611.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method of a mobile device comprising:
collecting a first datum at a sensor of the mobile device, the first datum being associated with a sensed condition of the mobile device;
accessing a second datum at a memory accessible to the mobile device, the second datum being associated with a usage history of at least one application resident at the mobile device; and
selecting an application different from the at least one application based on the collected first and second data.

2. The method of claim 1, wherein collecting the first datum at the sensor of the mobile device includes collecting location information associated with the mobile device from a location sensor of the mobile device.

3. The method of claim 1, wherein accessing the second datum at the memory accessible to the mobile device includes monitoring the usage history of the at least one application to generate the second datum and storing the second datum at the mobile device.

4. The method of claim 1, wherein accessing the second datum at the memory accessible to the mobile device includes monitoring the usage history of the at least one application to generate the second datum and storing the second datum at a remote device capable of data communication with the mobile device.

5. The method of claim 1, wherein selecting an application different from the at least one application includes selecting an application resident at the mobile device.

6. The method of claim 1, wherein selecting an application different from the at least one application comprises:
selecting an application resident at a remote device capable of data communication with the mobile device;
downloading the application resident at the remote device to the mobile device; and
providing a notification associated with the downloaded application to the mobile device.

7. The method of claim 1, wherein the usage history of the at least one application resident at the mobile device includes information about one or more previous accesses of the at least one application at the mobile device.

8. The method of claim 1, wherein the usage history of the at least one application resident at the mobile device includes a usage history of the at least one application associated with a location of the mobile device.

9. The method of claim 8, wherein the usage history of the at least one application associated with the location of the mobile device includes usage of the at least one application by the mobile device at the location of the mobile device.

10. The method of claim 8, wherein the usage history of the at least one application associated with the location of the mobile device includes usage of the at least one application by a device other than the mobile device at the location of the mobile device.

11. A mobile device comprising:
a sensor configured to collect a first datum associated with a sensed condition of the mobile device;
a memory accessible to the mobile device, the memory storing a second datum associated with a usage history of at least one application resident at the mobile device; and
a processor capable of selecting an application different from the at least one application based on the collected first and second data.

12. The mobile device of claim 11, wherein:
the sensor includes a location sensor; and
the first datum includes location information associated with the mobile device.

13. The mobile device of claim 11, wherein:
the memory includes a device memory of the mobile device; and
the second datum includes a usage history stored at the device memory.

14. The mobile device of claim 11, wherein:
the memory includes a remote memory of a remote device capable of data communication with the mobile device; and
the second datum includes a usage history stored at the remote memory.

15. The mobile device of claim 11, wherein the processor selects the application, which is different from the at least one application, the application being resident at the mobile device.

16. The mobile device of claim 11, wherein:
the processor of the mobile device selects the application, which is different from the at least one application, the application being resident at a remote device capable of data communication with the mobile device;
a communication component of the mobile device downloads the application resident at the remote device to the mobile device; and
an output component provides a notification associated with the downloaded application to the mobile device.

17. The mobile device of claim 11, wherein the usage history of the at least one application resident at the mobile device includes information about one or more previous accesses of the at least one application at the mobile device.

18. The mobile device of claim 11, wherein the usage history of the at least one application resident at the mobile device includes a usage history of the at least one application associated with a location of the mobile device.

19. The mobile device of claim 18, wherein the usage history of the at least one application associated with the location of the mobile device includes usage of the at least one application by the mobile device at the location of the mobile device.

20. The mobile device of claim 18, wherein the usage history of the at least one application associated with the location of the mobile device includes usage of the at least one application by a device other than the mobile device at the location of the mobile device.
